(19) United States
(12) Patent Application Publication
(10) Pub. No.: US 2008/0184154 A1
(43) Pub. Date: Jul. 31, 2008

(54) MATHEMATICAL SIMULATION OF A CAUSE MODEL

(76) Inventors: Tanvir Y. Goraya, Bratenahl, OH (US); Richard J. Boland, Chagrin Falls, OH (US)

Correspondence Address: Renner, Otto, Boisselle & Sklar, LLP, 19th Floor, 1621 Euclid Ave., Cleveland, OH, 44115, US

(21) Appl. No.: 12/023,248

(22) Filed: Jan. 31, 2008

Related U.S. Application Data
(60) Provisional application No. 60/887,413, filed on Jan. 31, 2007.

(51) Int. Cl. G06F 3/048

(52) U.S. Cl. 715/772; 715/771

(57) ABSTRACT

Computer software allows for users to easily construct and simulate operation of cause models in which elements interact as parts of a system. A graphical user interface (GUI) allows a user to place cause model elements and connect the elements with relationships that allow changes in one element to cause changes in one or more other elements. The graphical user interface may also be used to configure characteristics of the elements and/or the relationships. The computer software allows simulation of performance of the cause model by perturbation of levels in the elements, or by other setting of initial conditions. The software may allow for various feedback of the model during simulation. Levels of the elements or of the intensity of interactions through relationships may be communicated by the software to the user during a cause model simulation, in any of a variety of ways.

A claim to priority under 35 USC 119 is made to U.S. Provisional Application No. 60/887,413, filed Jan. 31, 2007, which is incorporated herein by reference in its entirety. A prior publication, US 2004/0015906 A1, is also incorporated herein by reference in its entirety.

### BACKGROUND OF THE INVENTION

1. Technical Field of the Invention

The invention relates in general to software and methods for modeling interactive systems.

2. Description of the Related Art

Prior attempts to model interactive systems have suffered from drawbacks of not being intuitive, and from lacking in modeling sophistication and flexibility. One prior approach has been use of a cause map. The cause map has named elements, with links between elements indicating a positive or negative impact (correlation) between a change of value at one linked element with a change of value at another linked element. Such models tend to be counterintuitive and confusing for a novice user, in that a negative link can result in an increase of a value at a downstream linked element. Furthermore, since they traditionally indicate only the direction of cause or correlation between elements, they do not lend themselves to simulation.

Another approach is a “Systems Dynamics” approach, modeling an interactive system as a series of tanks and pipes. The effect of one element on another is represented as a flow from one tank (element) to another. Such a “system dynamics” approach is a method of creating simulations between elements and relations but is not based on a cause map. System dynamics is an approach to modeling complex systems that is based on stocks (rather than elements), flows (rather than relations) and decision valves controlling the rate of flows between stocks (rather than indications of the impact of a relation). The systems dynamics approach conceives of a stock as the quantity of a resource of interest to the system dynamics modeler (materials, machinery, people, information, money, etc.) It conceives of flows as the movement of resources between stocks. It conceives of decision valves, which control flows, as being explicit mathematical equations that the user must define in sufficient detail to allow the equations to be used in an iterative calculation of the flows between stocks during each sequential period of the simulation. Such models lack flexibility, and can be difficult to intuitively grasp. In addition, a high degree of sophistication can be required in order to formulate the necessary equations. Even a minor change in the system may require its equations to be rewritten, or at the least the entire simulation needs to be rerun.

From the foregoing it will be appreciated that improvements would be desirable in the field of modeling interactive systems.

### SUMMARY OF THE INVENTION

According to an aspect of the invention, a method of creating a robust mathematical simulation of a cause map includes the transformation of a cause map with sparse qualitative indicators into a network of reliable mathematical models, which depict how the elements in the model will behave over time.

According to another aspect of the invention, software utilizes a graphical user interface (GUI) to allow a user to set up elements and relationships of a cause map. The setting up process, including the placement and characterization of the elements and relationships, may be an equationless process, not requiring any numerical input by the user. Equationless, as the term is used herein, is defined as not involving numerical input, but rather providing a qualitative estimation of relevant parameters. For example, a person may have a sense of the general warmth of an environment, without knowing or being able to provide an exact temperature.

According to still another aspect of the invention, software provides a graphical presentation of cause model performance during simulated operation of a cause model.

According to yet another aspect of the invention, software provides an audible presentation of cause model performance during simulated operation of a cause model.

According to a further aspect of the invention, a computerized method of configuring a cause model includes the steps of: placing and configuring multiple cause model elements; and placing and configuring one or more relationships between the cause model elements. The placing and the configuring of the cause model elements and the relationships is an equationless placing and configuring using a graphical user interface (GUI) of a computer.

According to a still further aspect of the invention, a computerized method of utilizing a cause model includes the steps of: simulating operation of the cause model; and during the simulating, graphically representing performance of the cause model.

According to another aspect of the invention, a computerized method of configuring a cause model includes the steps of: placing and configuring multiple cause model elements; and placing and configuring one or more relationships between the cause model elements. The placing and the configuring of the cause model elements and the relationships is an equationless placing and configuring using a graphical user interface (GUI) of a computer, that enables the model to be simulated.

According to yet another aspect of the invention, a computerized method of utilizing a cause model includes the steps of: simulating operation of the cause model; and during the simulating, graphically representing performance of the cause model. The graphically representing performance includes changing an appearance of relationships of the cause model that causally link elements of the cause model.

According to still another aspect of the invention, a computerized method of utilizing a cause model includes the steps of: simulating operation of the cause model; and during the simulating, graphically representing performance of the cause model. The method further includes, during the simulating, audibly representing performance of the cause model.

According to a further aspect of the invention, a computerized method of utilizing a cause model includes the steps of: simulating operation of the cause model; and during the simulating, graphically representing performance of the cause model. The graphically representing performance includes, for a series of steps in the simulating operation, changing appearance of elements of the cause model based on changes in value of the elements in a given step, and changing appearance of relationships between elements based on changes of value of the elements caused by the relationships in the step.

According to a still further aspect of the invention, a computerized method of utilizing a cause model includes the steps of: selecting one or more elements and/or relationships of the model for initial firing(s); and graphically displaying, for subsequent steps, firings in the model resulting from the initial firing(s).

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings:

FIG. 1 is a conceptual drawing of a cause model in accordance with an embodiment of the present invention;

FIG. 2 is a diagram of a cause model that may be created using software in accordance with an embodiment of the present invention;

FIG. 3 is a screen shot of an entry screen for entering a cause model, using a graphical user interface, in accordance with an embodiment of the present invention;

FIG. 4 is a screen shot of a first output screen, showing results of a cause model simulation, in accordance with an embodiment of the present invention;

FIG. 5 is a screen shot of a second output screen, showing results of a cause model simulation, in accordance with an embodiment of the present invention;

FIG. 6 is a screen shot of a third output screen, showing results of a cause model simulation, in accordance with an embodiment of the present invention;

FIG. 7 is a screen shot of a fourth output screen, showing results of a cause model simulation, in accordance with an embodiment of the present invention;

FIG. 8 is a screen shot of a fifth output screen, showing results of a cause model simulation, in accordance with an embodiment of the present invention;

FIG. 9 is a screen shot of a sixth output screen, showing results of a cause model simulation, in accordance with an embodiment of the present invention;

FIG. 10 is a flow chart of various operations in building and modifying a semantic memory model (s-model), in accordance with an aspect of an embodiment of the present invention;

FIG. 11 is a flow chart of various operations in building and modifying an episodic memory model (e-model);

FIG. 12 is a flow chart of various operations in building and modifying a cause model (d-model), in accordance with an aspect of an embodiment of the present invention;

FIG. 13 is an illustration of a first matrix input window in accordance with an aspect of an embodiment of the present invention;

FIG. 14 is an illustration of a second matrix input window in accordance with an aspect of an embodiment of the present invention;

FIG. 15 is an illustration of a third matrix input window in accordance with an aspect of an embodiment of the present invention;

FIG. 16 is a screen shot showing a brainstorming feature in accordance with an aspect of an embodiment of the present invention;

FIG. 17 is an illustration of a cause map or model used in the present invention;

FIG. 18 is a screen shot showing the cause map or model of FIG. 17 in the process of being assembled;

FIG. 19 is a screen shot showing the full model of FIG. 17;

FIG. 20 is a screen shot showing a graphical representation of a simulation of performance of the cause model of FIG. 17 at a first point in the simulation;

FIG. 21 is a screen shot showing a graphical representation of a simulation of performance of the cause model of FIG. 17 at a second point in the simulation;

FIG. 22 is a screen shot showing a graphical representation of a simulation of performance of the cause model of FIG. 17 at a third point in the simulation;

FIG. 23 is a screen shot showing a graphical representation of a simulation of performance of the cause model of FIG. 17 after many steps;

FIG. 24 is a screen shot showing a ribbon graph representation of simulation results;

FIG. 25 is a screen shot showing a spiral graph representation of simulation results;

FIG. 26 is a screen shot showing a bar graph representation of simulation results at a single simulation step;

FIG. 27 is a screen shot showing a bar graph representation of simulation results at multiple simulation steps;

FIG. 28 is a screen shot showing initial firings in an animation process; and

FIG. 29 is a screen shot showing firings in a subsequent step of the animation process.

### DETAILED DESCRIPTION

Computer software allows for users to easily construct and simulate operation of cause models in which elements interact as parts of a system. A graphical user interface (GUI) allows a user to place cause model elements and connect the elements with relationships that allow changes in one element to cause changes in one or more other elements. The graphical user interface may also be used to configure characteristics of the elements and/or the relationships. Such characteristics may include for example the value (or level) of the elements and the level of influence of the relationships. Other user-entered characteristics may include predictions for the long-term and short-term behavior (changes) of the elements and/or the relationships, and an indication of the user's feelings regarding the element and/or relationship (whether the user likes or dislikes the thing or method associated with the element/relationship). The element and relationship characteristics may be entered using the GUI without requiring any numerical input from the user, for example by using slider bars, pull down or drop down menus, or the like.

The computer software allows simulation of performance of the cause model by perturbation of levels in the elements, or by other setting of initial conditions. The software may allow for various feedback of the model during simulation. Levels of the elements or of the intensity of interactions through relationships may be communicated by the software to the user during a cause model simulation, in any of a variety of ways. For example, the software may be configured to visually indicate cause transmissions along the relationships (changing a level of a downstream element as an effect of a change in a level of an upstream element), such as by flashing of the relationship, or by having a thickness of the line indicating the relationship change in proportion to the intensity of the interaction between elements along the relationship. Alternatively firing or pulsing relationships could be brighter or otherwise more visually noticeable. As another example, the software may cause aural signals, such as tones, to be played to indicate interactions along the relationships. Visual and/or aural patterns may thus be created, allowing the user to obtain an understanding of the interactions among the elements and relationships of the cause model.

A cause model (also referred to herein as a cause map) is a directed graph showing the elements of a theory and the relations or relationships among those elements. The elements of a theory are factors, forces, or variables that can be measured. The relations among elements are links between elements that indicate there is an influence, correlation or causal effect between two elements and its direction.

A method creates a robust mathematical simulation directly from a cause model (also known as a theory model, directed di-graph or influence diagram). By adding minimal qualitative data and enabling the transformation of a cause map into a reliable mathematical simulation of how the elements in the model will behave over time, the makers of a cause map can test the implications of their subjective understandings of causal relations at work in a domain of interest to them.

The method of direct mathematical simulation of a cause map enables learning by allowing a simple drawing of a theory to become an animated representation of its expected behavior, which can then be compared to actual outcomes. Thus the logical consequences of one's theory of a situation can be made visible and available for self-reflection. In the absence of our method, an individual would have to write sets of mathematical equations representing their understandings of the elements and relations in their theory (or cause map), and would have to give quantitative values to each variable in their set of equations. The method allows for a robust mathematical simulation to be created using only the drawing of a theory as a cause map, in the form of elements and relations, along with a sparse set of qualitative descriptors. The sparse qualitative data may include a value of the element, feeling regarding an element or relationship, short-term and long-term trend of an element or relationship, and a descriptive element name.

A cause map is composed of the elements and relations among them that the creators of the diagram believes to be an explanation of the past, current, or future state of a phenomena of interest to them. It could be a physical, psychological, social, economic, political, or other situation of interest.

Elements in a cause map are any concept to which a measurement can be attached. The measurement can be quantitative on a numeric scale, or qualitative on a scale of high to low, strong to weak, or similar qualitative distinctions.

Relations among elements are indications of cause and effect, or correlations, between two elements. Relations between elements have 1) direction, 2) functional shape, 3) strength (also referred to as intensity), and 4) degree of immediacy. In the following examples, we will refer to the relation between two elements, T and G. More complex cause maps are constructed from such pairs of elements and relations shown in the example

Relations have the property of direction, which indicates the flow of causality between two elements, with causality flowing from one element to another. Direction is the sequence of the cause and effect between the two elements. A relation that is directed from T to G means that a change in T is associated with a change in G. The direction of a relation can be indicated with a line (dashed, straight or wavy) and an arrow point, with a line (dashed straight or wavy) of differing degrees of thickness, or other pictorial means depicting the intended sequential flow of cause and effect.

The functional shape of the relation between two elements can range from positive, through neutral, to negative. The functional shape of a relation is the Cartesian plot of changes in the relationship showing, for example, how changes in the quantity of T are related to changes in the degree of positive or negative effect on G. Functional shapes may be linear or non-linear, such as sigmoid, U-shaped, or wave-like. Any point on a functional shape will be associated with a positive, neutral or negative relationship between the two elements. A positive relation directed between two elements (T to G) means: “other things being equal, an increase in T causes an increase in G.” A negative relation directed between two elements (T to G) means: “other things being equal, an increase in T causes a decrease in G.” A neutral relation means no cause or correlation effect is expected.

The strength (or intensity) of a relation indicates the intensity of the causal effect between two elements. The strength of a relation is indicated by the slope of the line, at any point on the relation's functional shape. The steeper the slope, the greater will be the causal effect, and the stronger the relationship.

The degree of immediacy refers to how quickly a change in one element (T in our example) is propagated to another element (G) through its directed relation. The degree of immediacy can range from instantaneous to requiring multiple iterations through the cause map.

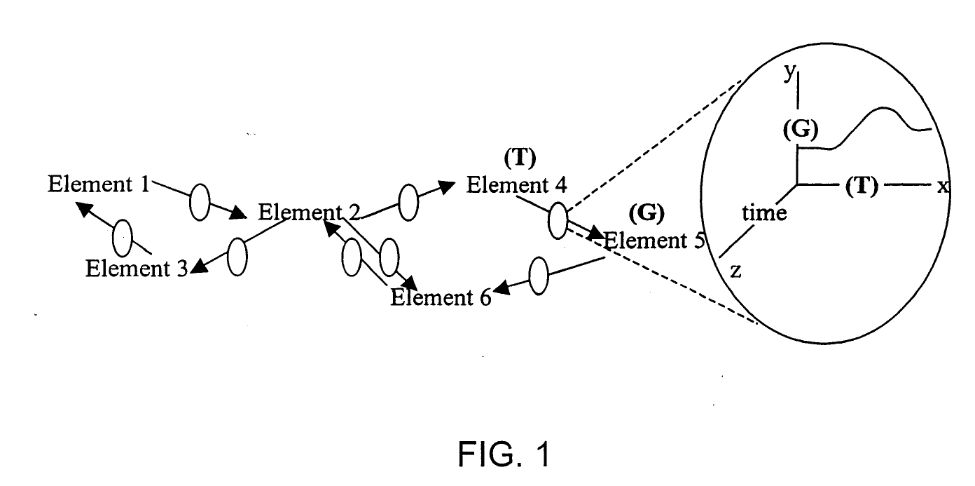

In the representation shown in FIG. 1, relations are shown as arrows and elements are shown as text. Elements can be shown as an object of any shape along with the name of the element. Relations can be shown in any other pictorial depiction connoting the direction of the relationship. An example of a pictorial relationship is a straight line between the elements, with an arrow indicating the direction of effect from the relationship. The arrow points toward the downstream element (in terms of causation), the element that is affected by the upstream (affecting) element.

Relationships can be positive, in that an increase in the affecting or causing upstream element results in an increase in the affected downstream element, and a decrease in the upstream element results in a decrease in the downstream element. A relationship may also be negative, in that an increase in the upstream element causes a decrease in the downstream element, and vice versa. These two types of relationships may be denoted by a plus sign (+) for a positive relationship, and a minus sign (−) for a negative relationship. It will be appreciated that the positive and negative relationships may be linear or nonlinear, and that more complicated relationships are possible.

In addition, it will be appreciated that a model element may act on itself, through a self-referencing relationship. Such a self-referencing relationship may have any or all of the characteristics described herein with regard to relationships where one element acts upon another. Possibilities for self-referencing relationships include self-suppressing relationships and self-exciting relationships. Characteristics of self-referencing relationships may be user-selected or a user-supplied model.

Another possibility for relationships is one that acts on a certain input until an output criteria is met. Such relationships may either be self-referencing or between separate elements.

In the illustration the oval along each relation shows the functional shape, strength, and degree of immediacy in the form of an n-dimensional Cartesian space. An example of an oval conveying this information is shown in larger scale for the directed relation between Element 4 (T) and Element 5 (G).

The simulation of a cause map is achieved by using the information depicted in the drawing of a map, such as the map shown in FIG. 1 and described above. The simulation transforms qualitative information about the relationships in the map (direction, functional shape, strength and immediacy) into a sequence of changes in the relative quantities of each element, as time passes from one simulation period to the next.

User determined indications of the initial magnitude of an element, as well as the limits or boundaries of the magnitude that an element can be expected to display, are used to trigger alarms if boundary conditions are exceeded during the simulation. User determined indications of the expected changes in relative magnitude of the elements over time can be compared to results of the simulation, further enabling the user to learn through feedback.

The simulation is computed by a high speed, high accuracy, and proprietary hybrid algorithm. The simulation is based on a pulse of one or more elements, and a tracing of the initial pulse effect through the set of relations and elements in the map. Pulses can be one time, instantaneous increases or decreases of one or more elements in the map, or can be periodic or continuous increases or decreases of one or more elements.

Compared with “Systems Dynamics” methods, the method of direct simulation of a cause map eliminates the need to specify mathematical equations, and enables the maker of the cause map to directly simulate the behavior of its elements over time, based only on the qualitative information included in the drawing of the map. The notion that a cause map is an adequate basis for simulating the behavior of a complex system of relations among elements is specifically denied by the developers of the Systems Dynamics methods at MIT, and related software (known as “Stella”, and also as “I Think”).

Another advantage of the present method is that the use of an n-dimensional Cartesian coordinate as one way of indicating the direction, shape, strength and immediacy of a relation between two elements is unique and not used by any other group working with cause maps. People working with cause maps as static pictures of the relations among elements indicate the type of relation with a + (positive) or a − (negative) label, an S (same) or O (opposite) label, or similar binary labels.

Yet another feature of the present method is the use of pulsing an element or elements selected by the theory modeler to initiate the simulation.

Still another new feature is the indication of boundary conditions and initial values in cause maps. The boundary conditions and initial values are dependent upon the idea of creating a simulation from the theory model or cause map.

The method described above may be used for creating mathematical simulations for a variety or purposes, and by a wide variety of users with different levels of sophistication. In one series of applications, the method may be used as an educational software tool for grades 4 through graduate school and continuing professional development. Such software tools may be aimed at developing the skill of scientific thinking, by guiding students in the construction and testing of theories in a wide range of subject areas.

In such tools, students or other users are guided in drawing pictures of a theory, which are the elements and relations they believe to be at work in a situation. The situation they theorize could be anything from the behavior of a chemical reaction, the dynamics of rainforest ecology, the causes of the civil war, or the experience of peer pressure. Their theories can then be tested by the tools' ability to analyze the logic inherent in the theory (static analysis) and by animating the theories with sophisticated simulation and optimization capabilities (dynamic analysis).

The software may utilize a hybrid algorithm developed to solve otherwise intractable computational problems. The software enables users to add a few qualitative descriptors of the elements (high/low, more/less, growing/shrinking) and relations (positive/negative, immediate impact/delayed impact, strong/weak) in their theory. With that sparse qualitative data, the software tools can produce a rigorous mathematical simulation, showing the behavior of the elements over time. Thus the software helps students create theories in any discipline (history, science, literature, etc.) and test those theories by comparing their predicted outcomes to actual outcomes. This is the essence of learning in any discipline.

Such software can enable even young users to have a remarkably exciting learning experience. It allows them to represent a complex idea and to have others react to their thoughts before they can write an essay describing them. Such activities may improve student interest and literacy rates by engaging students in the process of exploring their own thoughts and engaging in dialogue with others about them.

It will be appreciated that references herein to software are in general to instructions on a computer-readable medium or in computer memory, executable by a computer. Such computer-readable medium may be a magnetic medium, an optical medium, or a volatile or non-volatile memory, to give but a few broad examples. Functions performed by software may also alternatively be performed in whole or in part by hardware.

The cause maps and/or mathematical simulations of users' theories may be saved in repositories for communities of users, where maps may be clustered according to similarities in their situations, subject matter, elements, relations and/or dynamic behaviors. These clusterings will become the basis for “meta-analysis” and “meta-dialogue” among members of the communities, in which they learn to see structural patterns in their own concepts and theories both within and across subject domains.

A method and a system employ a graphical interface and a template comprising of predefined components and controls for eliciting and capturing tacit or intangible knowledge which allows for holistically analyzing a plurality of dynamically-changing cause-and-effect relationships, correlations, dichotomous relationships, multi-valued relationships, fuzzy-logic relationships, and/or probabilistic relationships, (including Bayesian relationships) based on tacit or intangible knowledge.

According to one aspect, the system and/or method allows converting of (perhaps) sparse human qualitative judgments into an interactive model, using a simple graphical interface for eliciting and capturing tacit or intangible knowledge (henceforth referred to as a d-model).

According to another aspect, the system and/or method can be used to create an adaptive and dynamically changing set of an underlying plurality of mathematical, logical, and AI-based models. Such models can be used for a “what-if” analysis or sensitivity analysis, to see the effect if previously unseen inputs are provided to the model.

Another possible use is for tuning or self-promulgation of a model. According to this use, if the results are not acceptable, the user does not need to modify the parameters in the model but simply needs to pull or push the outputs on the graphical display. This results in self-promulgation of the requisite changes in the model.

A third possible use is in categorization or clustering. The various factors in the model can be categorized using a suitable similarity measure by changing the measure. The results are displayed as dendrograms where similar factors are grouped together according to the criteria specified for similarity.

A fourth possible use is recall based on a partial or full cue. In the d-model, a past model can be recalled using a similarity measure when a partial or full cue is provided to the software.

A fifth possible use is weighted, constrained, optimization or goal-seeking. Given a model, one can specify the desired outputs, the relative trade-offs allowed in making any choices, and any constraints on the inputs and the model is used in a direct optimization manner to find many optimal solutions. The user is provided with a list of these solutions. He can then click through each solution. As each solution is selected the corresponding inputs and outputs are selected and the user can conduct a what-if analysis before moving on to the next optimal solution.

A sixth possible use is an extended visualization using sensitivity analysis. The user can specify one or two independent variables. Then all other variables or factors can be automatically drawn as 2-D graphs or 3-D surfaces, which are obtained by plotting the dependent variable as a function of the one or two independent variables when an independent variable is changed from its minimum to maximum value at regularly spaced intervals while holding the other variable constant at its mean value. Color is used as an additional dimension to convey information.

A seventh possible use is statistical analysis and reposting of the dynamically changing model. This overcomes the shortcoming of cause maps that leads systems dynamists' to admonish against using correlated variables in a cause map.

A further use as a repository of models serves as a surrogate for e-model's episodes from which an episodic memory can be constructed and employed, as described in the appended patent application.

Cause and effect elements or entities (also known as factors, forces, or variables) may have an approximate qualitative measure that can be assigned using, for example, a crude slider-bar or any arbitrary scale with an upper and lower bound. Other characteristics may also be assigned to such elements, for example value, bias, belief, short and long term trend, emotion or feelings about element such as degrees of like or dislike, and/or affect. Color may be used as an additional indicator along with the aforementioned characteristics in formulae which can then be decomposed in the manner with which the functions of the s-model in the appended patent application are handled.

A relationship may be depicted by a directed link from one element to another showing the relationship from causative element to the impacted-upon element. The relationship may be in the form of an influence, logical relationship (abstractions or propositions), formulaic relationship (from any scientific field), or generalizable statistical correlation between the two elements from the origin to the destination. For the sake of ease of expression by the general user who has no particular technical or other background, any of a variety of functional relationships may be entered or selected graphically, or by other suitable means. Examples of such functional relationships include approximate mathematical functional mapping, a value, a trend composed of constituent short and long term trends, a direction of influence depicted by either a linear or non-linear graphical functional relationship chosen from an ensemble of pre-programmed menu of relationships, a simple positive or negative influence, a strength of the functional relationship, and a time-frame over which the function behaves; that is decelerates, stops, or accelerates. Graphical entry or selection may be accomplished with the aid of a wide variety of suitable input devices. For this purpose time is an additional dimension onto which the original functional form is mapped. The functional form may thus be rendered in n-1 dimensions where the nth dimension is time. This would appear different than the n-1 dimensional representation drawn by the user. The new representation will be used for internal computations. The user may have the choice to view the original and/or new representations. In systems theory models and in cause maps similar expression of time are commonly displayed at an exquisitely indecomposable and non-dynamic level as a simplistic delay symbol. This provides none of the richness of dynamics afforded by the time dimension and its folding into the n-1 dimensional functional form as discussed here in the d-model.

The present method and software provides numerous advantages over prior systems and methods. A user may pose what-if questions with no limit on the number of variables that might be perturbed. Simulations may be performed by changing multiple values through the easy to use qualitative interface. A user may perform constrained, weighted, goal seeking. The user may view the correlations and other statistical data of importance as such data shift over time.

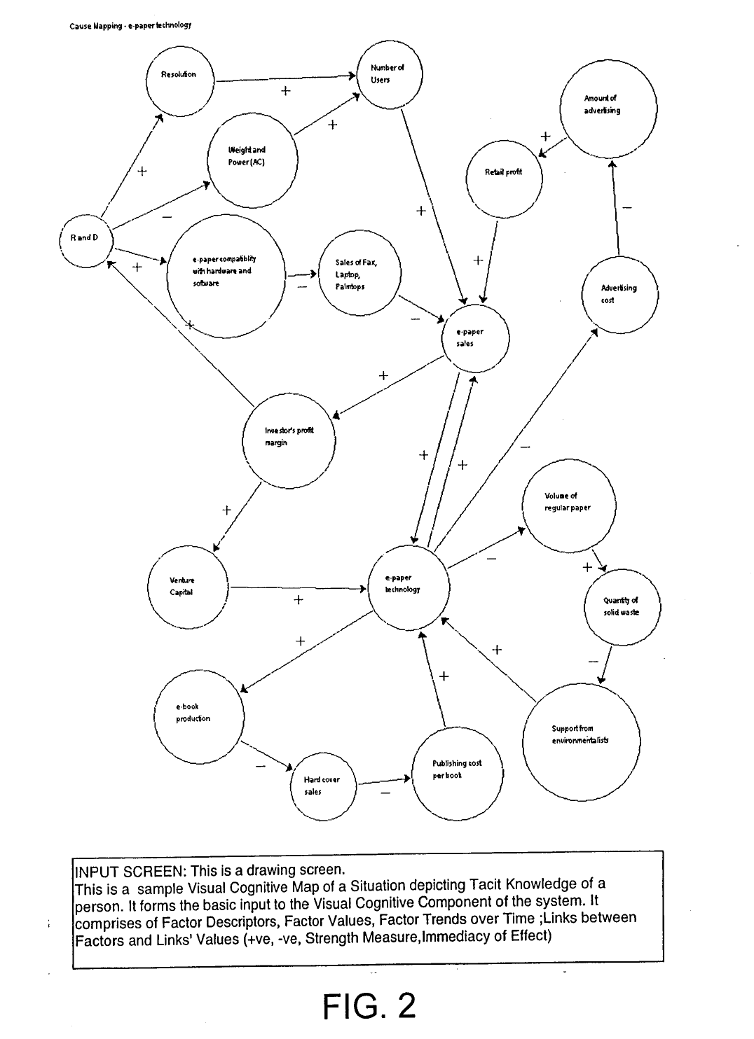

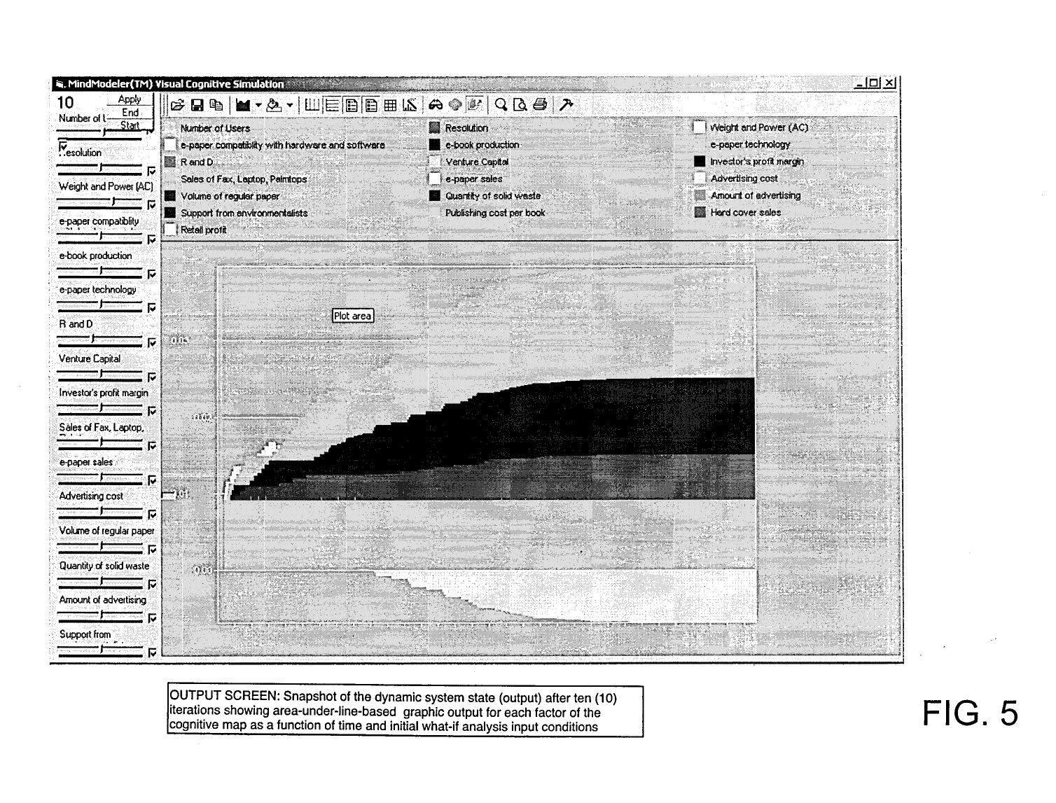

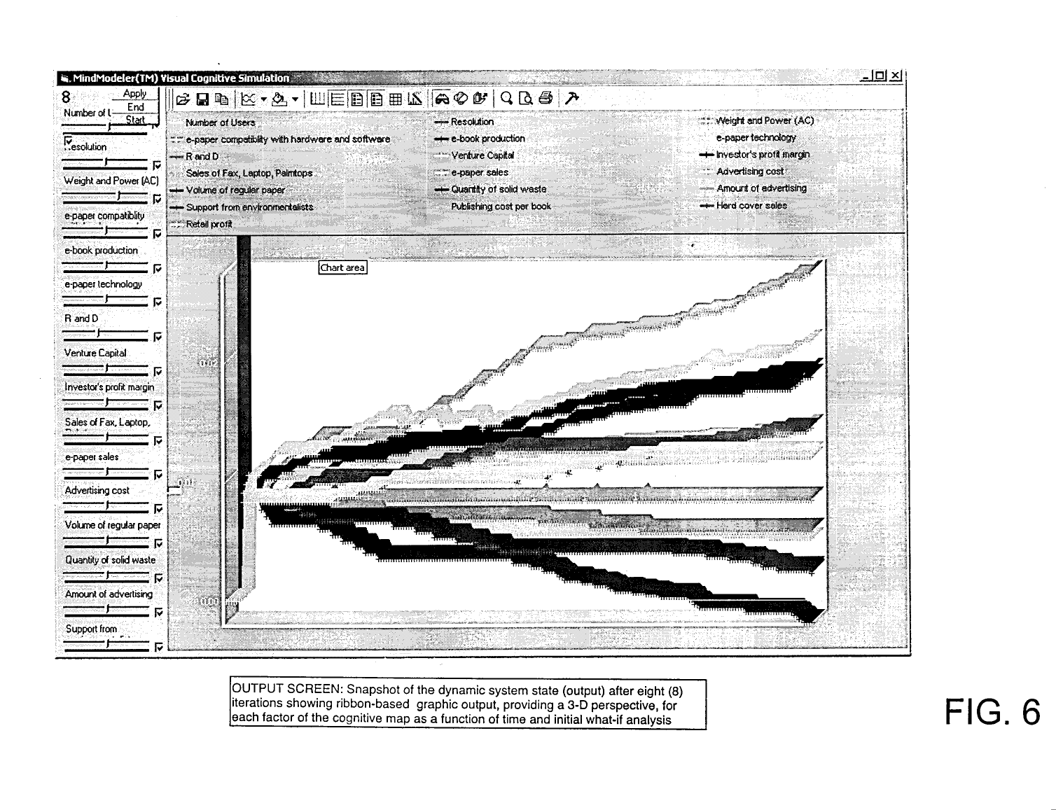

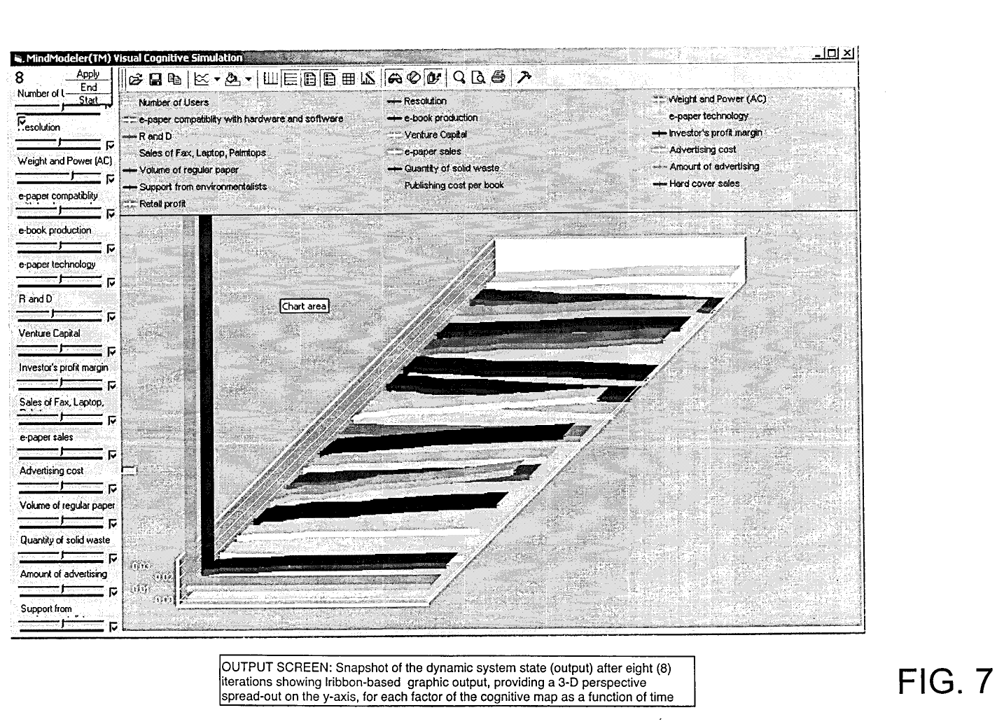

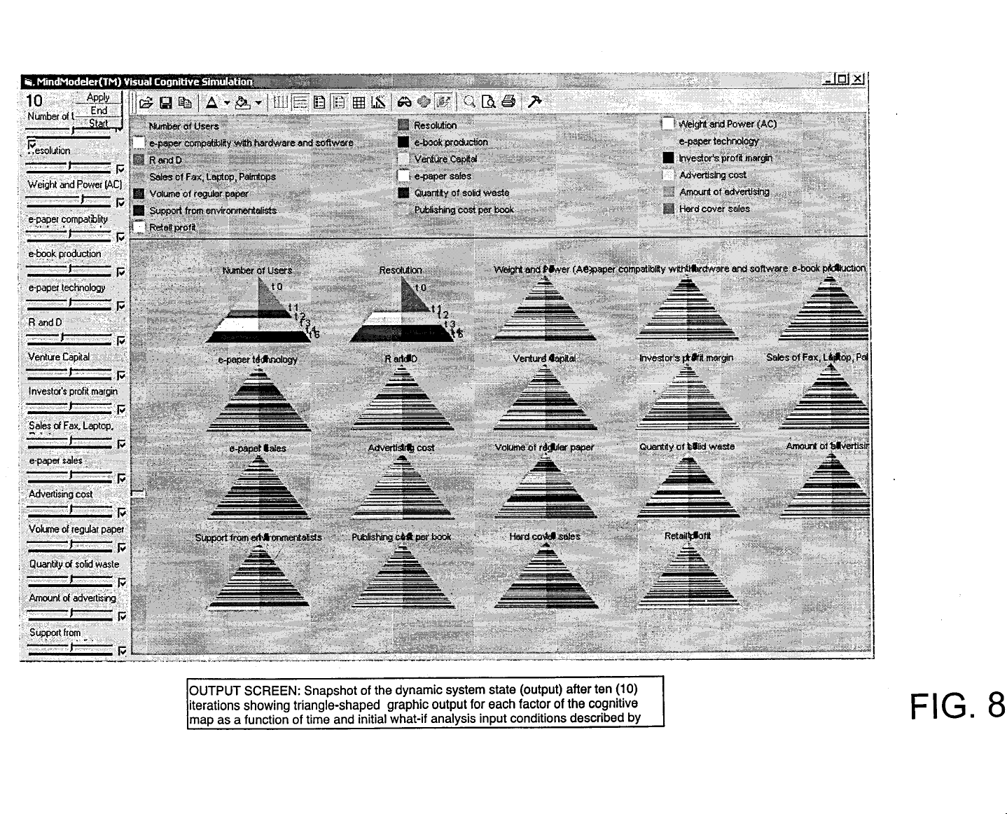

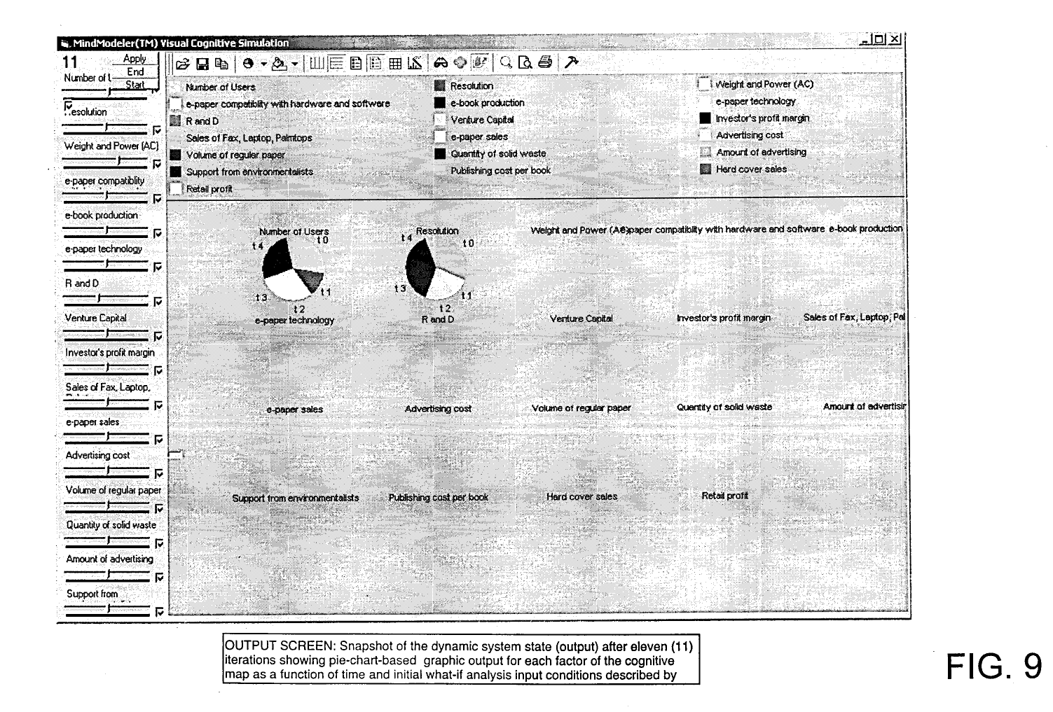

FIGS. 2-12 illustrate various other details, features, aspects, and examples of the method, and of software embodying the method. FIG. 2 shows a sample input screen for a user to create a visual cognitive model or map 10 of a situation depicting tacit knowledge of a person. The cause model 10 shown in FIG. 2 includes cause elements or nodes 12 and relationships 14 between the elements 12. The cause elements 12 in FIG. 2 are depicted as circles, although they could alternatively be represented as other shapes, such as ovals or rectangles.

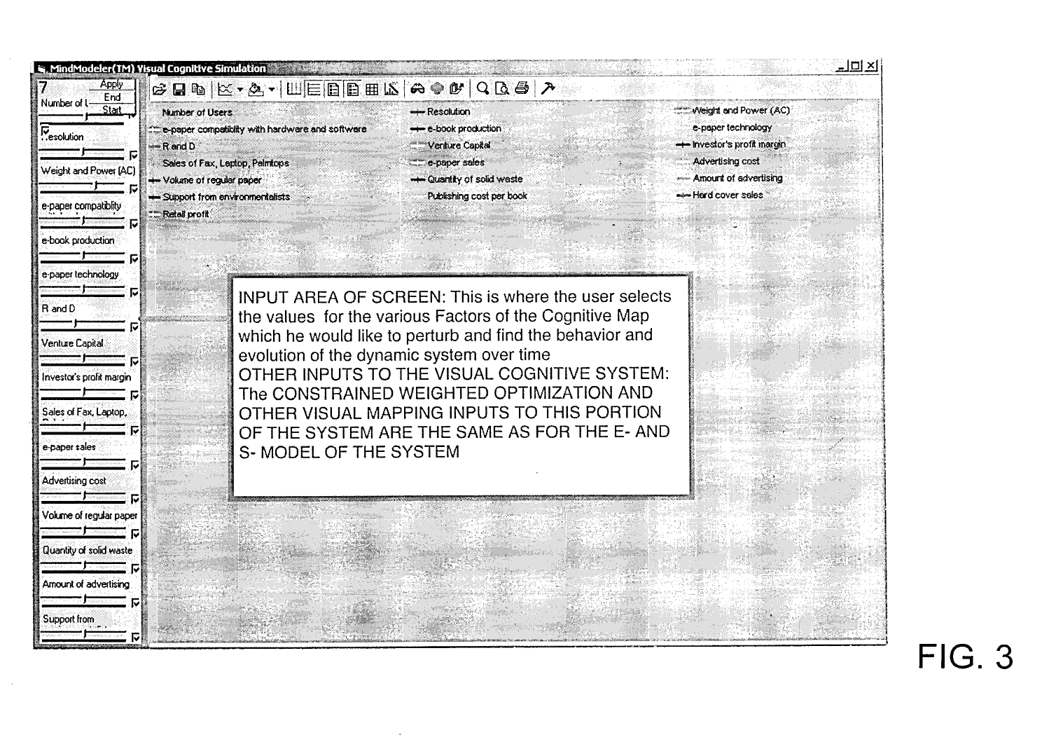

The elements 12 may be placed on a computer screen using a graphical user interface (GUI), for example using an input screen such as that shown in FIG. 3. A mouse, touch pad, joystick, track ball, or other similar such device may be used to place the elements 12 at desired locations on a computer screen, to make the cause model 10.

The relationships 14 may also be placed on the input screen using the GUI. For example, the user may drag a mouse from the location of one element to the location of another element to specify a relationship between the two elements, with the direction of the dragging being the downstream direction with regard to influence of one of the connected elements on the other. The creation of a relationship 14 may involve setting up the relationship with certain default value, which then may be altered by the user.

The GUI may also be used to input characteristics for the elements 12. The characteristics are input without requiring a numerical selection by the user. It has been found that users experience anxiety when required to select a number associated with an element or relationship. Thus the GUI may involve entry methods that do not involve a user selecting a number for any characteristic of an element or relationship. The GUI may include such mechanisms as slider bars or pull down menus to enable a user to select characteristics of an element or relationship without entering a number or selecting a number for a parameter of the cause model.

The element characteristics that are selectable by the user include an initial level of the element, a prediction of short-term behavior of the element, a prediction of the long-term behavior of the element, and an indication of the user's positive or negative emotions associated with the element. The predictions and the indications of emotion may not have any direct bearing on the results of the simulations, but may enhance the value to the user of the modeling process and the simulation process. The predictions may allow the user to easily compare expectations to results, for example providing a visual indication, even during the simulation, of the results and also the predictions. The indication of user emotions associated with an element may allow the user (and others) to compare the importance of certain elements in affecting a cause model, and the user's emotions associated with those elements. Such an indication might indicate a disconnect between what is influential in the cause model, and what is satisfying for those involved in one or another aspect of the activities associated with the cause model. In other words, a logical cause map (the cause model) may differ from the emotional cause map (the user or participant emotions associated with the elements and relationships).

The relationship characteristics selectable by the user include characteristics such as intensity of the relationship (the relative magnitude of the upstream element on the downstream element), a prediction for the short-term effect of the relationship (a prediction of the short-term level of the amount of the effect of the relationship, the amount or frequency of the influence through the relationship), a prediction for the long-term effect of the relationship, and an indication of emotions associated with the relationship.

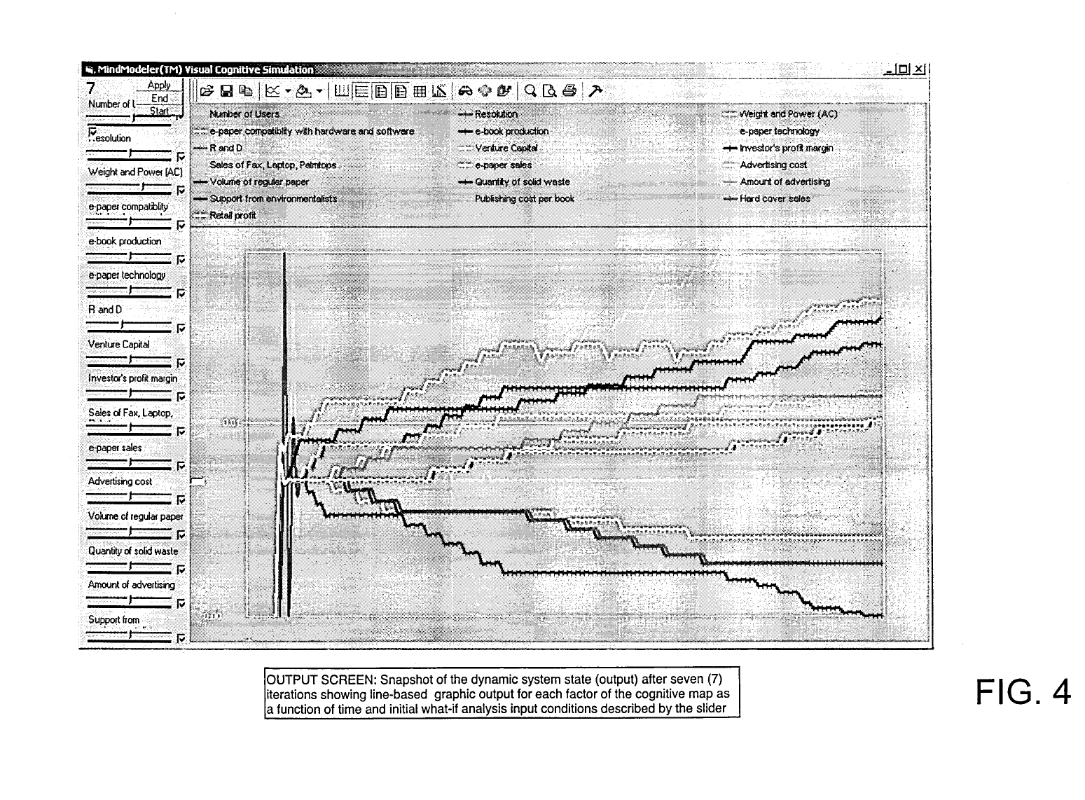

FIGS. 4-9 show various ways of showing output of a simulation of the cause model 10 of FIG. 2. The graphs may plot or otherwise show various parameters of the cause model 10, such as the level at one or more of the cause elements 12, or the “firings” or pulses along one or more of the relationships 14, showing the influence of upstream elements on downstream elements. The graphs may be updated over time as the simulation proceeds, providing a user with an indication of a pattern or patterns that may provide insight into how the cause model 10 performs in its operation. For example, certain short-term, medium-term, or long-term patterns in element levels or relationship firings may become evident. The various patterns can be merged and can interact in different ways. The different effects on different of the elements may be an observed result. Another insight from the results may be the importance of some relationships in affecting the progression of the cause model.

The graphical output of the model may be displayed in any of a variety of suitable ways. Line graphs may be used, with different lines representing the levels of differently elements or the magnitudes of the firings of different of the relationships. Different elements and/or relationships may have different colors and/or line styles (e.g., solid, dashed, dotted) associated with them. Gauges may be used to present levels at the cause elements or nodes, and/or magnitudes of the firings or pulsing along the relationships.

Alternatively or in addition, the elements 12 and/or the relationships 14 may have an appearance that may change to provide an indication of results in the simulation of operation of the cause model 10. For example, line thickness, line style, and/or color of the boundaries of elements 12 and/or the lines representing the relationships 14 may change with the element level or the magnitude or relationship firing.

As another way of communicating the outcome of a simulation of the model, the results may be communicated by sound. Various tones may be associated with various of the elements 12 and/or the relationships 14. As an example, various tones associated with respective relationships may sound in a pattern that corresponds to firings of the relationships (causing an upstream element to affect a downstream element). The tones may be assignable by the user to various of the elements 12 and/or the relationships 14. The pattern of tones may communicate to a user a pattern associated with the results of the simulated operation of the cause model 10.

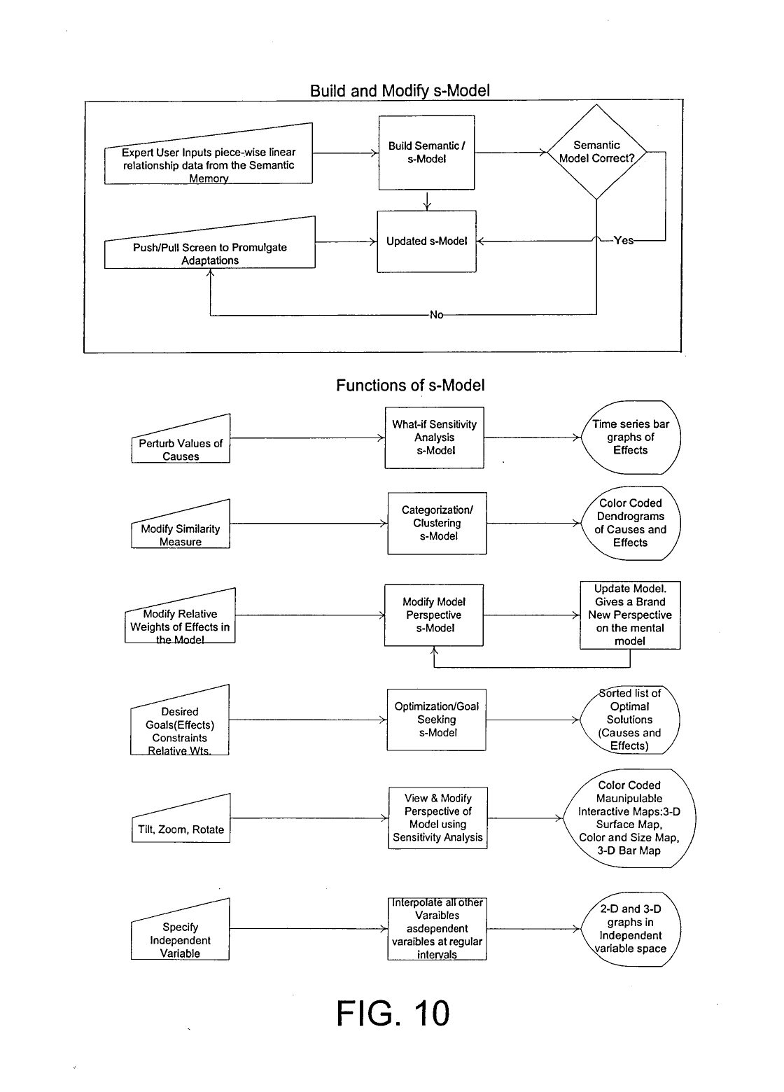

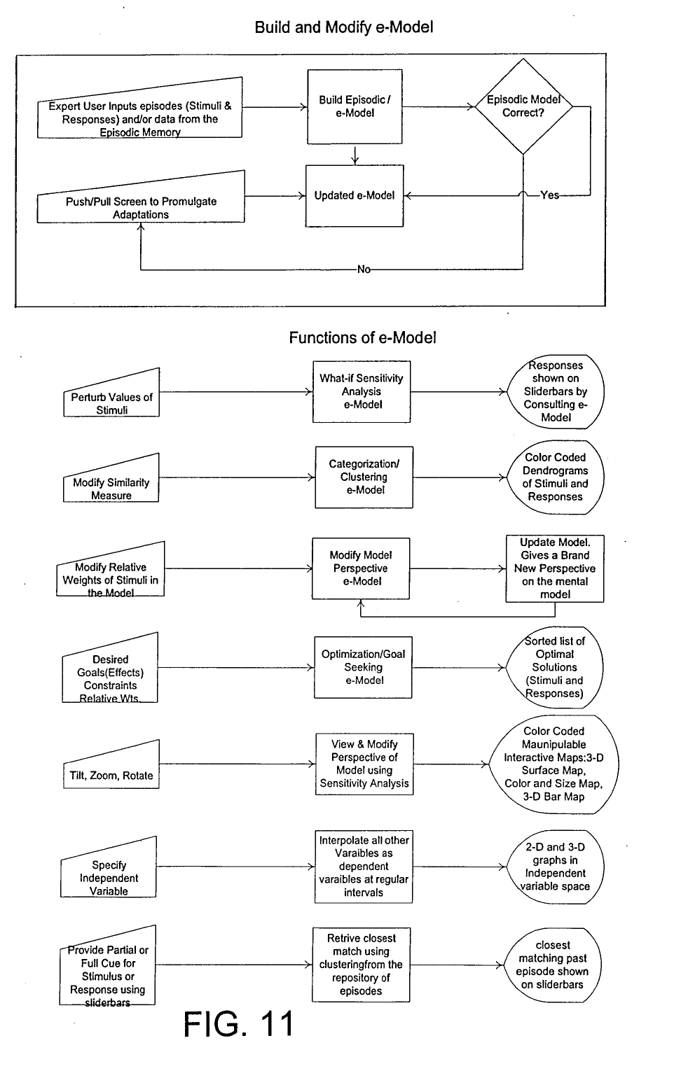

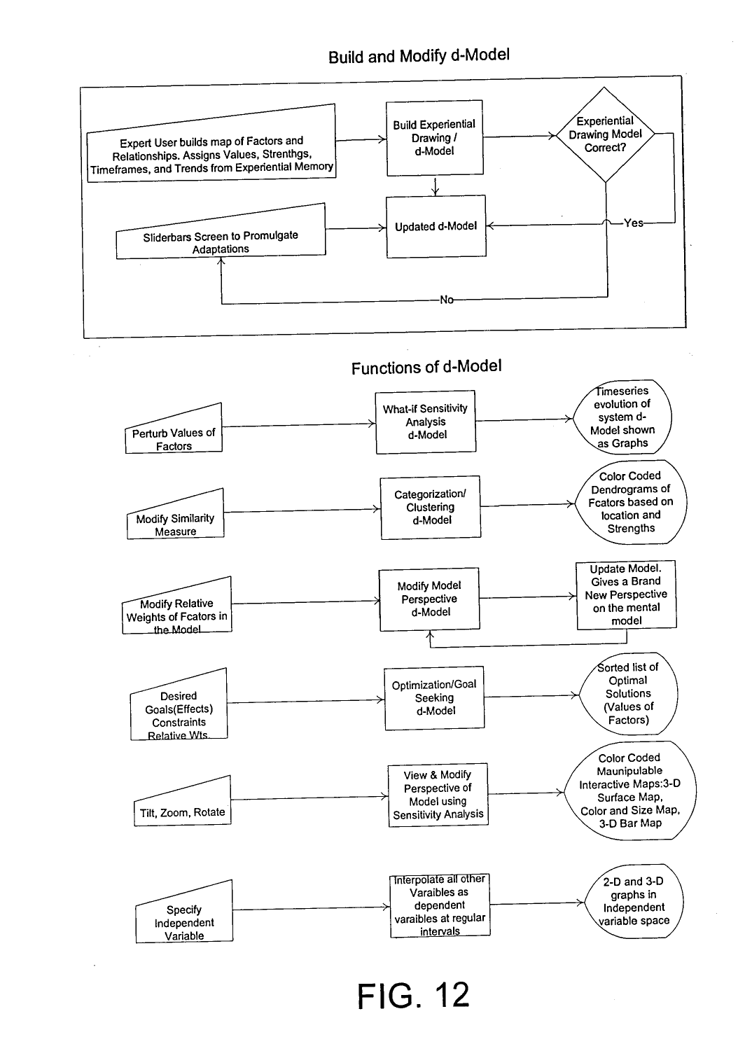

FIGS. 10-12 show flow charts of various aspects of models used in the program. FIG. 10 is a flow chart of various operations in building and modifying a semantic memory model (s-model). FIG. 11 is a flow chart of various operations in building and modifying an episodic memory model (e-model). The s-model is created from the supposed mapping of the semantic memory or cause and effect relationships that an expert is capable of expressing. In the presently preferred embodiment, the s-model is a linear model that utilizes parallel distributed processing representation. The e-model is constructed from past experiences of an expert and is designed to mimic episodic memory. In the presently preferred embodiment, the e-model is a nonlinear model that utilizes parallel distributed processing representation. FIG. 12 is a flow chart of various operations in building and modifying a cause model (d-model).

The GUI of FIGS. 2 and 3 may be used to produce a cause model, by adding the elements and the relationships, and by perhaps changing the default characteristics of the elements and/or relationships. Levels of the elements may be perturbed (increased or decreased in level) to start a simulation to examine the effect on other parts of the cause model. The simulation may be examined to get insight how the parts (elements and relationships) of the cause model interact with one another. The effect of different conditions and/or changes or perturbations in those conditions may be examined. The user and/or observer may discern patterns, find patterns, find anomalies as well as patterns, find similarities and/or dissimilarities and group them together, all without burdening the user with mathematics.

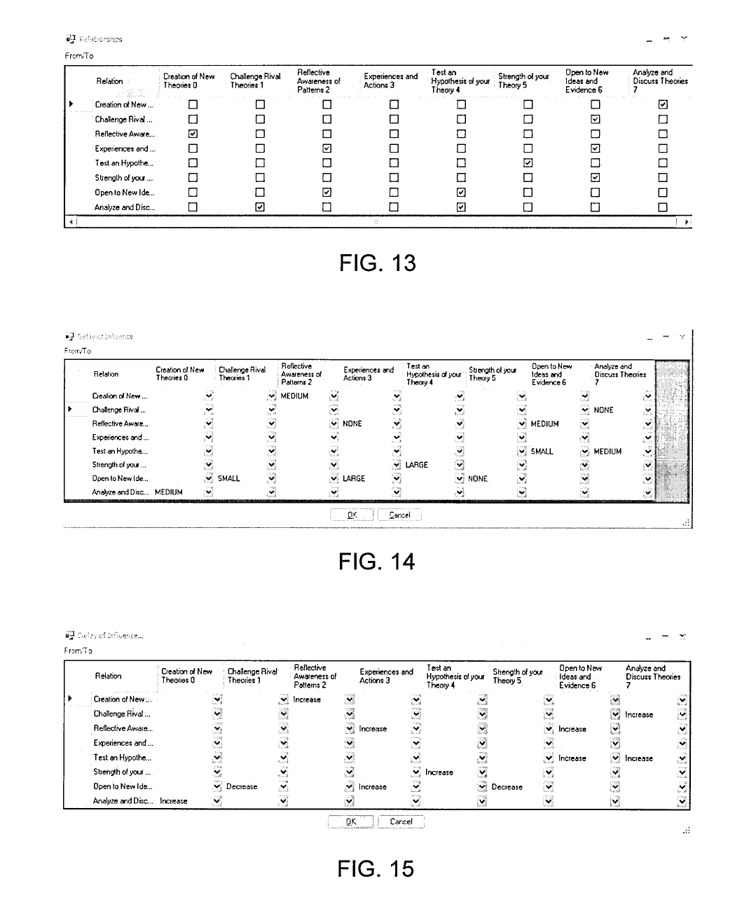

FIGS. 13-15 show various matrix windows that may be used for inputting information regarding elements and relationships between elements. The windows shown in FIGS. 13-15 allow a user to input names for elements (and perhaps for relationships), the connections of elements with relationships, and characteristics of the elements and relationships. The characteristics input using the matrices may be any of those described above. The characteristics may be input using any of a variety of mechanisms, including sliders, buttons, and pull down menus.

Entry of information in a matrix form may appeal to some users as an ordered way of setting up a model. Some users prefer the order of using a table to the relatively freeform entry that is involved in placing and manipulating graphical elements. User inputs into the matrices may be used to create a cause model that is displayed to the user. The displayed model created from the data in the matrices may be further manipulated by the user after creation. This further manipulation and revision may be performed using a matrix or matrices, or by using another type of interface (such as by deleting or adding relationships in the graphical cause model).

FIG. 13 shows a matrix used for selecting which elements are to be linked by relationships. A series of check boxes may be used to create relationships between different elements, or to create a relationship of an element to itself. FIG. 14 shows a matrix which has pull-down menus to select a delay of influence for relationships between elements (or a relationship of an element to itself). FIG. 15 shows a matrix with pull down menus used to select increase or decrease in characteristics of a relationship. It will be appreciated that a wide variety of types of matrix inputs may be used to input a variety of element and relationship characteristics.

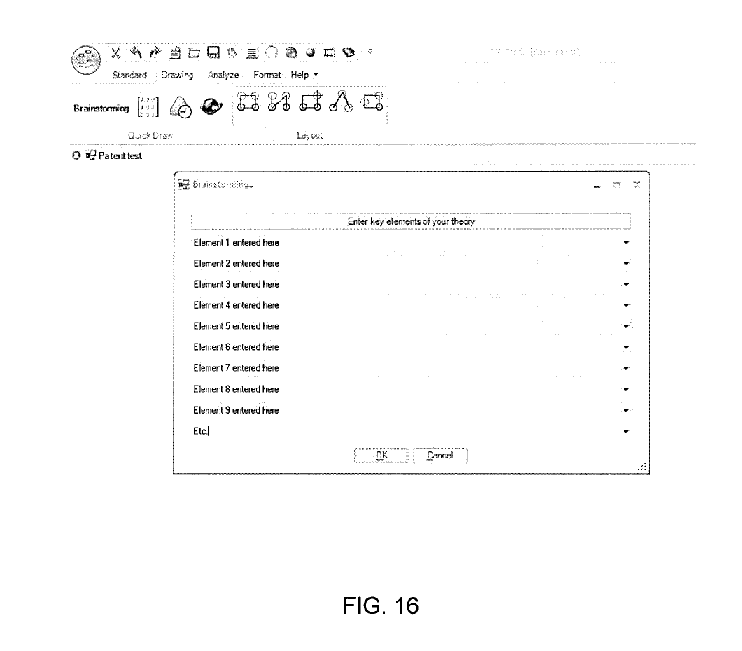

FIG. 16 illustrates a brainstorming feature of the present invention. In the brainstorming feature a user enters names for a number of elements, for example as a list of elements, which are then placed in a graphical display. The feature allows a user to quickly enter information regarding a number of elements, for example to initiate the process of building a cause model. After the graphical representation is created of the elements, the user may use the GUI to make connections between the elements, for example by dragging a cursor form one element to another element. It will be appreciated that it may be quicker and more efficient to enter names of multiple elements at one time, rather than having to name and place the elements one by one.

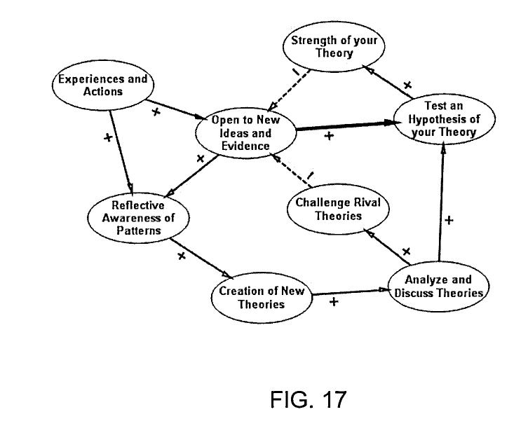

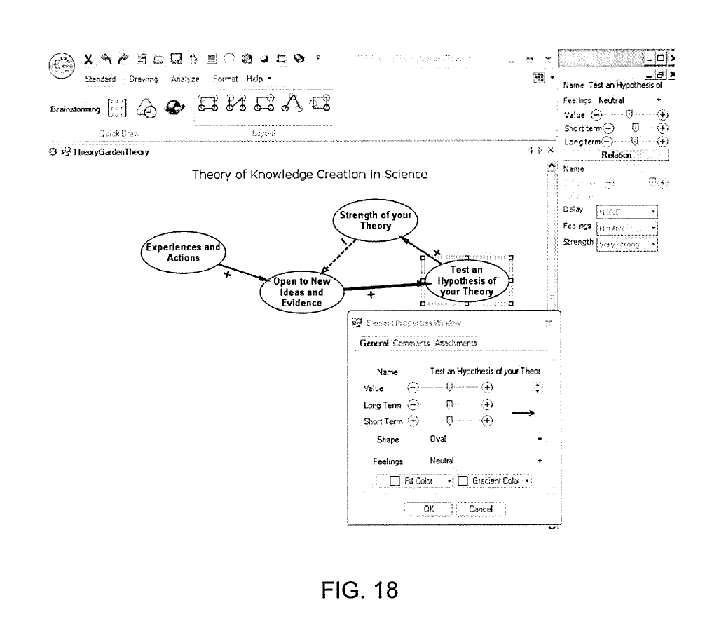

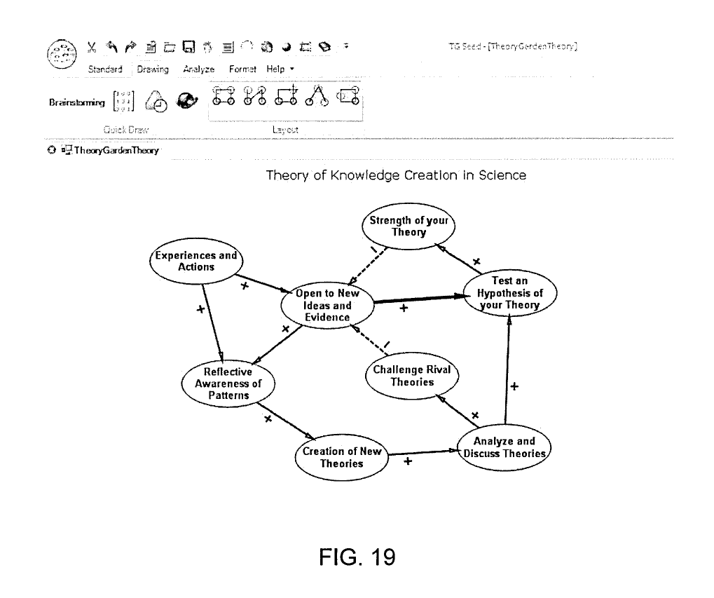

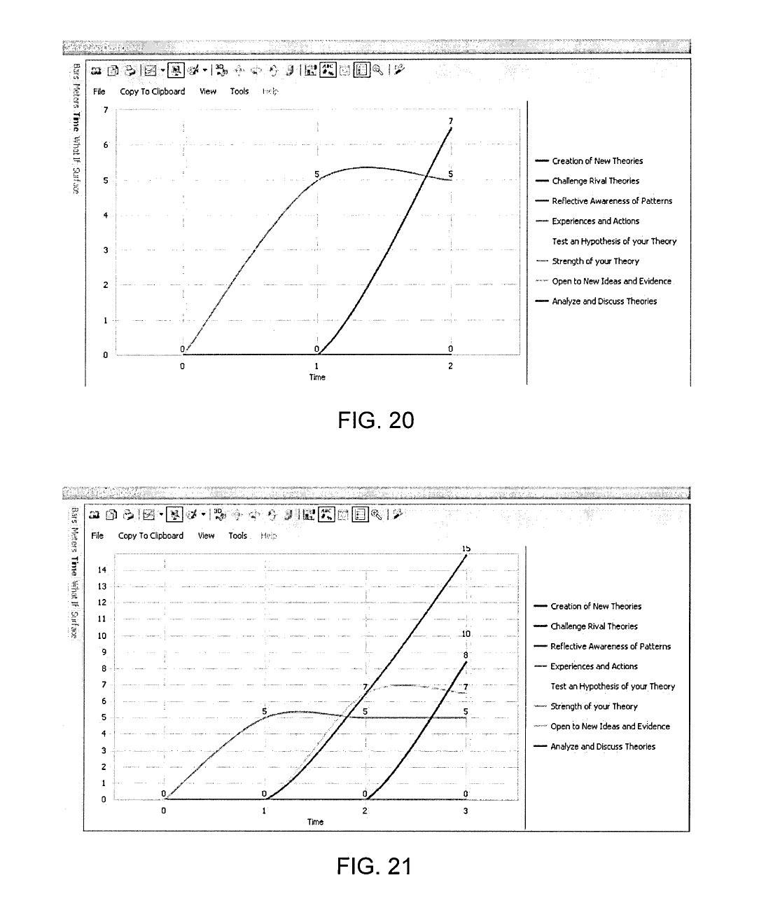

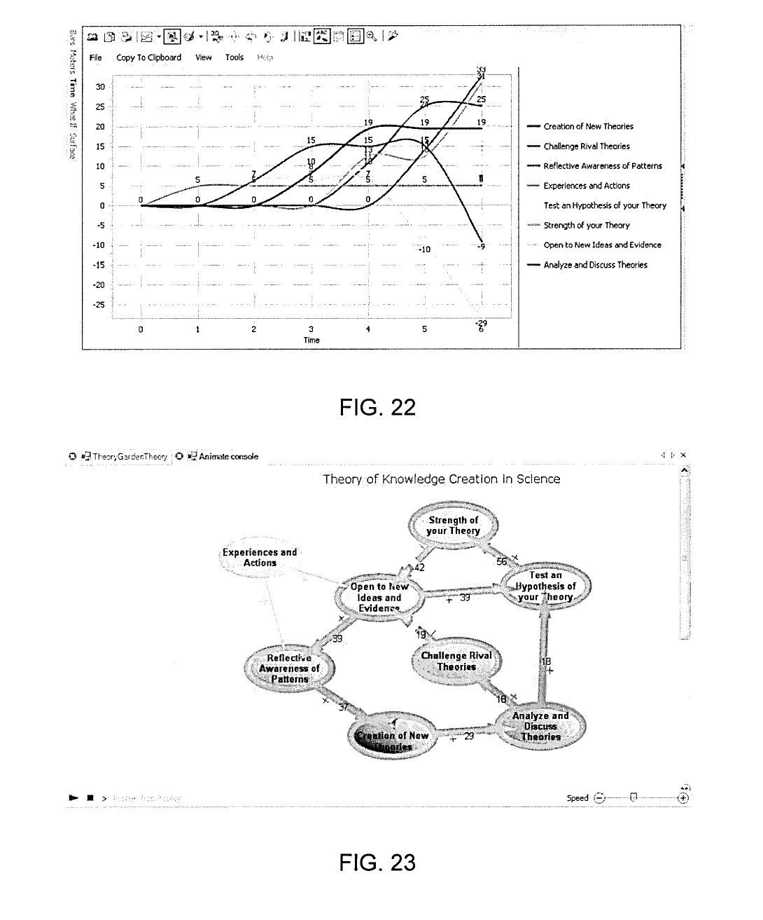

FIG. 17 illustrates a cause model created using the methods and steps described above. FIG. 18 shows the model partially laid out, before all of the elements and relationships have been added. FIG. 19 shows a screen shot of the full model. FIGS. 20-22 are graphs of results of simulating operation of the cause model of FIG. 17 at various steps in the simulation process. FIG. 20 illustrate results of steps early in the simulation process. FIGS. 21 and 22 illustrate steps later in the simulation process, with the values at different elements plotted over the steps of the simulation. The appearance of the elements and the relationships indicates the number of “firings” (changes in value) along the relationships and into the elements. Changes in appearance of the elements and the relationships include one or more of changes in thickness, changes in color, and flashing of the relationships and/or elements. More than one cycle in the model that overlap (have at least one element in common) can lead to simultaneous firings of elements and relationships. The result can be growing feedback within the model, with firings increasing in subsequent steps as the simulation proceeds. FIG. 23 shows a simulation after many steps, with the many firings indicated in thickened appearance of the elements and relationships, and different colors for different of the elements and relationships. It will be appreciated that the differences in thickness, color, and/or other differences in appearance may be given different meanings. The shifting patterns of firings in a simulation provides a user with an easily-graspable way of understanding the interactions of the elements through the relationships, and thus with a grasp of the way that overlapping cycles of causal relations affect the behavior of the simulated cause model. These patterns also may be observable from the graphical displays of FIGS. 20-22.

It will be appreciated that the firings of the elements may be visually represented in other visual ways, such as by changing color or blinking. Also, the firing of elements and/or relationships may be indicated in other non-visual ways, such as by the playing of a chord or sequence of tones.

The simulation of FIGS. 17-23 may be run automatically from step to step. Alternatively the user may selectively move the simulation forward in individual steps or in small increments of steps. The user may be able to select between user-controlled simulation and automatically-run simulation, and may be able to select between the two during a simulation. In addition, the results of a simulation may be stored for playback.

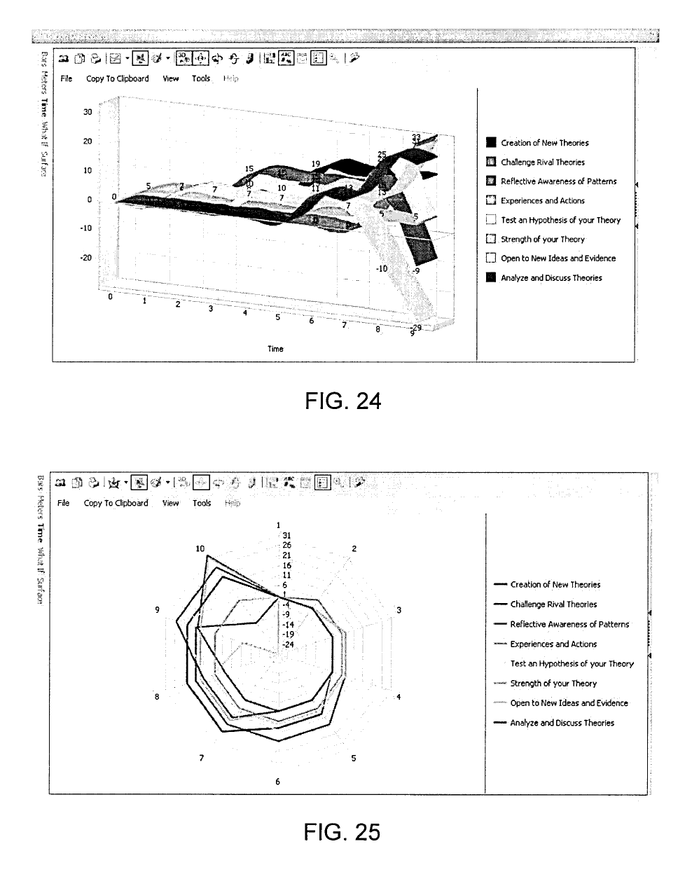

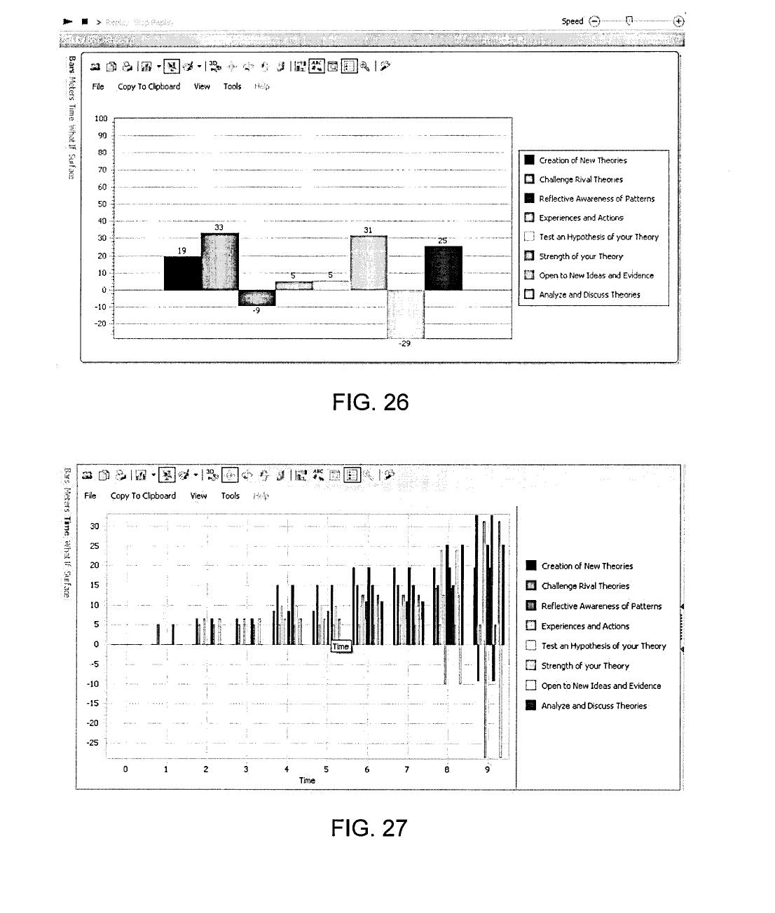

Various other ways may be used of presenting the cause model and the results of a simulation. FIGS. 24-27 show other types of graphs that may be used to show the pattern of simulation results (values at elements) over time. FIG. 24 shows a ribbon graph, FIG. 25 shows a spiral graph, FIG. 26 shows a bar graph of results at a single simulation step, and FIG. 27 shows a bar graph with simulation results for multiple simulation steps. The simulation results may be replayable, perhaps in conjunction with an audio track explaining participant reactions to the simulation and/or participant thoughts while creating the cause model.

Cause models may also be selectively animated by the user. By animation it is meant that the user may select one of more elements. These elements will fire and then in turn fire other elements that they are connected to through relationships and so on. The user may control this process in step by step to observe patterns in the firings. The consecutive firing of the elements gives rise to multiple consecutive and parallel firings of the elements showing the frequency of firings leading to near-chaotic situations. These firings, and the multiple loops they set up, may be difficult to predict a priori. The series of firings may allow the user to achieve greater insight into the interconnectedness of the cause model.

The firings may be depicted by flashing the relationships and the corresponding elements. The elements and relationships that are not firing may be dimmed, reducing their visibility to de-emphasize them. In addition, the frequency of firing of each one of those is shown by a number (frequency count of firing at time t) and/or by the width and/or the color of the element and the relationship in question. The firing may be simultaneously shown in various graphical formats of the user's choosing just as in simulation, as described elsewhere herein.

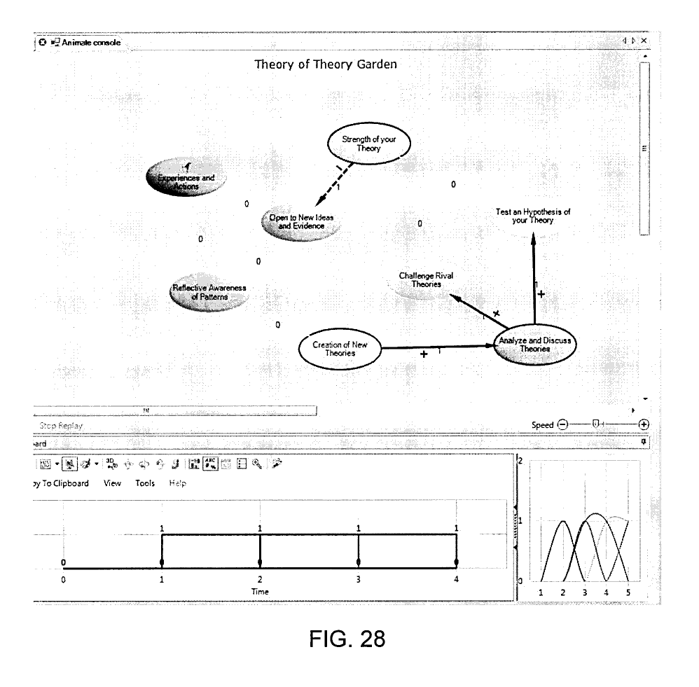

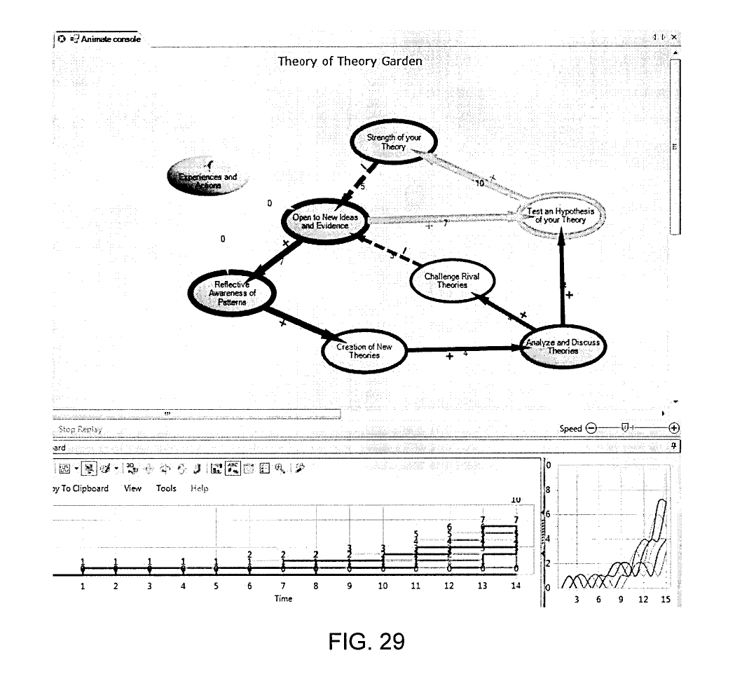

FIGS. 28 and 29 illustrate a pair of steps in an animation process. FIG. 28 illustrates initial user-selected firings, and FIG. 29 illustrates a step later in the animation process, showing firings in a subsequent step. FIGS. 28 and 29 also show other graphical representations of the current system state and the history of past firings in past steps.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A computerized method of configuring a cause model, the method comprising:
placing and configuring multiple cause model elements; and
placing and configuring one or more relationships between the cause model elements;
wherein the placing and the configuring of the cause model elements and the relationships is an equationless placing and configuring using a graphical user interface (GUI) of a computer, that enables the model to be simulated.

2. The method of claim 1, wherein the placing the relationships includes a dragging operation in the GUI from first element of the elements to a second of the elements.

3. The method of claim 2, wherein a direction of the dragging operation corresponds to a direction of causation between the first element and the second element.

4. The method of claim 1, wherein the configuring of the relationships includes using the GUI to select one or more relationship characteristics of the relationships.

5. The method of claim 4, wherein the one or more relationship characteristics includes an intensity of the relationship.

6. The method of claim 4, wherein the one or more relationship characteristics includes an emotion associated with the relationship.

7. The method of claim 4, wherein the one or more relationship characteristics includes a functional shape of the relationship.

8. The method of claim 4, wherein the one or more relationship characteristics includes a degree of immediacy of the relationship.

9. The method of claim 4, wherein the using the GUI to select one or more relationship characteristics includes using a slider bar of the GUI to select at least some of the one or more relationship characteristics.

10. The method of claim 4, wherein the using the GUI to select one or more relationship characteristics includes using one or more matrices of the GUI to select at least some of the one or more relationship characteristics.

11. The method of claim 4, wherein the using the GUI to select one or more relationship characteristics includes using one or more drop down menus of the GUI to select at least some of the one or more relationship characteristics.

12. The method of claim 1, wherein the configuring the elements includes using the GUI to select one or more element characteristics of the element.

13. The method of claim 12, wherein the one or more element characteristics includes a value of the elements.

14. The method of claim 12, wherein the one or more element characteristics includes an emotion associated with the element.

15. The method of claim 12, wherein the one or more element characteristics includes a predicted behavior of the element.

16. The method of claim 1, further comprising placing and configuring one or more of the self-referencing relationships for at least some of the cause model elements.

17. The method of claim 1, further comprising storing a sequence of steps in the placing and configuring of the cause model elements and the placing and configuring of the one or more relationships.

18. The method of claim 1, wherein the placing and configuring the multiple cause model elements includes having a user input names for elements on the list, and having the listed elements automatically placed by the computer.

19. A computerized method of utilizing a cause model, the method comprising:
simulating operation of the cause model; and
during the simulating, graphically representing performance of the cause model;
wherein the graphically representing performance includes changing an appearance of relationships of the cause model that causally link elements of the cause model.

20. The method of claim 19, wherein the graphically representing performance includes changing an appearance of elements of the cause model, based on values of the elements.

21. The method of claim 20, wherein the changing the appearance includes setting a thickness of the elements based on the values of the elements.

22. The method of claim 19, wherein the changing the appearance includes setting a thickness of the relationships based on behavior of relationships.

23. The method of claim 19, further comprising graphically representing emotions associated with at least one of elements of the model or relationships between elements of the model.

24. A computerized method of utilizing a cause model, the method comprising:
simulating operation of the cause model; and
during the simulating, graphically representing performance of the cause model;
further comprising, during the simulating, audibly representing performance of the cause model.

25. A computerized method of utilizing a cause model, the method comprising:
simulating operation of the cause model; and
during the simulating, graphically representing performance of the cause model;
wherein the graphically representing performance includes, for a series of steps in the simulating operation, changing appearance of elements of the cause model based on changes in value of the elements in a given step, and changing appearance of relationships between elements based on changes of value of the elements caused by the relationships in the step.

26. The method of claim 25, wherein the changing the appearance of the elements includes changing the appearance based on number of simultaneous firings of the elements.

27. The method of claim 25, wherein the changing the appearance of the relationships includes changing the appearance based on number of simultaneous firings of the relationships.

28. The method of claim 25, wherein the graphically representing is user controlled, with the user activating each of the steps of the simulating.

29. The method of claim 25, wherein the graphically representing automatically moves through the steps of the simulating.

30. A computerized method of utilizing a cause model, the method comprising:
selecting one or more elements and/or relationships of the model for initial firing(s); and
graphically displaying, for subsequent steps, firings in the model resulting from the initial firing(s).

31. The method of claim 30, wherein the graphically displaying includes flashing elements and/or relationships firing in the subsequent steps.
